(19) United States
(12) Patent Application Publication
(10) Pub. No.: US 2024/0390997 A1
(43) Pub. Date: Nov. 28, 2024

(54) CUTTING TOOL AND METHOD FOR PRODUCING A CUTTING TOOL

(71) Applicant: MAPAL Fabrik für Präzisionswerkzeuge Dr. Kress KG, Aalen (DE)

(72) Inventors: Thomas Feile, Ellwangen (DE); Martin Czapka, Ellwangen (DE); Alexander Suchanow, Bopfingen (DE); Dirk Sellmer, Aalen (DE)

(21) Appl. No.: 18/688,878

(22) PCT Filed: Aug. 19, 2022
(86) PCT No.: PCT/EP2022/073203

§ 371 Date: Mar. 4, 2024

(30) Foreign Application Priority Data
Sep. 10, 2021 (DE) 10 2021 123 537.5

(51) Int. Cl. B23C 5/28; B23B 27/10; B23B 51/06; B23C 5/00; B23C 5/02

(52) U.S. Cl. CPC B23C 5/28; B23B 27/10; B23B 51/068; B23C 5/006; B23C 5/02; B23C 2210/56

(57) ABSTRACT

The invention relates to a cutting tool, in particular for cutting, drilling and/or milling a workpiece, with a base body having a central axis, a front end and a rear end, wherein the cutting tool comprises at least one functional element for guiding and/or machining the workpiece, wherein the cutting tool comprises a channel system for supplying the at least one functional element with a cooling lubricant, wherein the channel system comprises a distributor element configured separately from the base body, and wherein the channel system comprises at least one distributor channel aligned transversely to the central axis.

The invention relates to a cutting tool and a method for manufacturing a cutting tool.

Cutting tools and methods for manufacturing them are known. These usually comprise guide and/or cutting elements which are attached to a base body. The base body is configured to rotate around a central axis so that the cutting elements can machine a workpiece along their circular cutting trajectory.

As friction and thus heat is generated when machining the workpiece and/or when guiding the tool in the workpiece, the use of a cutting tool usually leads to heating of the guiding and/or cutting elements. Excessive heating, i.e. overheating, leads to a reduction in the cutting effect and/or even a defect in the guiding and/or cutting elements or the workpiece.

To mitigate these effects, it is known to cool and/or lubricate cutting tools during operation. As lubrication reduces friction, this prevents heating in advance.

Cooling and/or lubrication can be provided separately by supplying a cooling lubricant to the area to be machined from an external source. However, cutting tools with an integrated cooling system are also known, whereby cavities are formed in the cutting tool through which cooling lubricants flow through the cutting tool and emerge in the area of the cutting and/or guide elements.

According to the principle of flood lubrication, large quantities of cooling lubricant are flushed through the cavities of the tool and/or sprayed onto the machining area from outside. As a result, for cutting tools that rely on this principle, the demand for cooling lubricant is very high. In addition, in order to enable flow rates as large as possible, very large cavities are formed in such tools. In addition, these tools, unless they are additively manufactured, often have narrow passages and edges along the flow path of the cooling lubricant due to their design, which impede the flow. These disadvantages are accepted in known solutions or compensated for by a further increase in the supply pressure and thus an increase in the flow rate and consumption of cooling lubricant.

Minimum quantity lubrication, where the principle of minimizing the amount of cooling lubricant applies, is difficult to implement in terms of design, which is why such cutting tools are usually manufactured using additive manufacturing methods. However, these are very heavy on the one hand and expensive to produce on the other.

The problem underlying the present invention is to create a cutting tool and a method for manufacturing a cutting tool, whereby the aforementioned disadvantages are avoided. In particular, it is the problem underlying the invention to create a cutting tool which is as light as possible, comprises a low demand for cooling lubricant during operation and provides a high cooling capacity. Furthermore, it is in particular the problem underlying the invention to create a cost-effective manufacturing process for a cutting tool and to save costs in the operation of the cutting tool.

The problem is solved by providing the present technical teachings, in particular the teachings of the independent claims and the embodiments disclosed in the dependent claims and the description.

The problem is solved in particular by providing a cutting tool, in particular for cutting, drilling and/or milling a workpiece, with a base body having a central axis, a front end and a rear end, wherein the cutting tool comprises at least one functional element for guiding and/or machining the workpiece, wherein the cutting tool comprises a channel system for supplying the at least one functional element with a cooling lubricant, wherein the channel system comprises a distributor element configured separately from the base body, and wherein the channel system comprises at least one distributor channel aligned transversely, in particular perpendicular to the central axis. As a result, the cooling lubricant can be transported to the area to be cooled in a targeted and efficient manner, whereby the cooling lubricant consumption during operation of the cutting tool is low and the cooling capacity is high. This also keeps operating costs low. In addition, the cutting tool is light and inexpensive to manufacture. In particular, this cutting tool can be constructed by welding, whereby no additive manufacturing processes are required. Furthermore, minimum quantity lubrication can also be carried out with this cutting tool, whereby good cooling and/or lubrication of the functional elements is created.

A cutting tool is understood here in particular to be a tool for machining the workpiece. The cutting tool is preferably configured as a rotary cutting tool, which is set in rotation around the central axis to machine the workpiece. In particular, this is understood to mean a drill, a milling cutter and/or a reamer.

A transverse alignment of the channel is understood here in particular to mean that the channel runs at least partially in a radial direction, i.e. not exclusively parallel to the central axis, in particular not exclusively on the central axis. A special case of transverse alignment is understood here to be orthogonal alignment, in which there is no component running parallel to the central axis.

The front end is understood here in particular to be the end facing the workpiece during machining. This front end of the cutting tool is located on the side of the cutting tool facing away from the rear end. Preferably, the at least one functional element is arranged in a radially outer region of the front end, where it comprises—in the operating state of the tool—a particularly circular cutting trajectory.

The rear end is understood here in particular to be the end facing away from the workpiece during machining. Preferably, a tool holder, in particular a hollow shank taper, is configured at the rear end, by means of which the cutting tool can be mounted in a machine tool.

A functional element is understood to be a cutting and/or guide element that in particular is to be cooled and/or lubricated. The functional element usually comes into contact with a workpiece to be machined and/or with chips removed from the workpiece, at least in an operating state. This results in high frictional heat in the area of the functional elements, in particular due to high rotational speeds, whereby the frictional heat can lead to overheating of the functional elements if the cooling is insufficient.

The terms cooling and lubrication and the effect of cooling interact with each other in that lubrication is preferably accompanied by a reduction in the frictional heat generated, so that heating is prevented. In particular, lubrication also improves chip removal, so that also in this respect friction and the associated heating is avoided. Cooling, on the other hand, leads to the cooling or removal of heat from an already heated object, in particular a functional element. The joint effect of cooling and lubrication is therefore reduced heating, i.e. a reduced temperature of the functional element in the operating state of the cutting tool. It is particularly preferable if both cooling and lubrication take place, as the effects complement each other.

Therefore, in the context of this document—even if only cooling or only lubrication is advantageous each in itself—the term cooling lubrication and/or cooling lubricant is used. This is understood to mean cooling and/or lubrication, or a means which is suitable and intended for cooling and/or lubrication.

The channel system is configured to guide the cooling lubricant from a cooling lubricant inlet, which is arranged in the area of the rear end, in particular on the tool holder, especially the hollow shank taper, to the point to be cooled in the area of the functional element. In the area of the functional element, a cooling lubricant outlet is preferably designed in the immediate vicinity of the functional element. It is important that the cooling lubricant outlet is arranged sufficiently close to the functional element so that the cooling lubricant comes into contact with the functional element during operation of the cutting tool or can at least cause indirect cooling and/or lubrication of the functional element by preferably cooling an immediate area around the functional elements, and the cooling effect also affects the functional elements themselves through heat conduction. The cooling lubricant outlet is in particular preferably formed in the functional element accommodation, which enables particularly efficient cooling and/or lubrication.

An oil-air mixture, in particular a so-called aerosol mixture, is used as the preferred cooling lubricant when operating the cutting tool described here. The components of the cooling lubricant can be supplied separately from each other or already supplied as a finished mixture. If the components are fed separately from each other, the channel system is configured as a two-channel system, whereby the components are initially fed separately and meet and mix with each other within the channel system. If, on the other hand, the finished mixture is to be fed in, the channel system is preferably configured as a single-channel system.

Preferably, several functional elements are configured, wherein most preferably several functional element pairs are configured, which each comprise a cutting element and a guide element.

Preferably, the cutting tool thus comprises as functional elements at least a first cutting element, to which a first guide element is assigned, and a second cutting element, to which a second guide element is assigned. Preferably, the first cutting element is offset from the second cutting element and the first guide element is offset from the second guide element in the circumferential direction and, in particular, arranged on the base body. In this case, the first cutting element and the first guide element form a first functional element pair and the second cutting element and the second guide element form a second functional element pair. Very preferably, the cutting tool comprises several axially offset functional elements, in particular functional element pairs. The arrangement of the functional elements can be selected to suit the intended use of the cutting tool. This means that the cutting tool can be used in a variety of ways and a desired cutting geometry can be implemented.

The base body is understood here in particular to be the part of the cutting tool on which the functional elements are configured or to which they can be attached, in particular to which they are fastened. The functional elements are configured integrally, in particular as a single material with the base body, or as separate elements. If the functional elements are configured separately from the base body, the cutting tool preferably comprises functional element accommodations into which the functional elements can be inserted and fastened, in particular clamped. In particular, cutting elements are clamped in corresponding cutting element accommodations and/or guide elements are clamped in corresponding guide element accommodations. As a result, these can be finely adjusted and/or replaced if necessary if their cutting force decreases or they are damaged. This means that the rest of the cutting tool, in particular the base body, can continue to be used, resulting in long-term cost benefits.

Preferably, the functional element accommodations are attached, in particular welded, to the outside of a circumferential surface of the base body. This makes the cutting tool simple and cost-effective to manufacture.

Alternatively, the functional element accommodations are configured integrally with the base body, whereby a high and long-term stability can be achieved.

The base body preferably comprises a cylindrical, in particular tubular, basic shape, at least circumferentially, whereby high stability and low weight are achieved. Preferably, therefore, an interior space of the base body is configured to be at least partially hollow, with the interior space of the base body being accessible via its two end faces, i.e.—in the direction of the rear end-a first opening on the clamping side and—in the direction of the front end-a second opening on the machining side, at least during an assembly step of the cutting tool. Preferably, the base body is configured to be at least hollow in such a way that the distributor element can be inserted into the interior space of the base body during assembly. The hollow interior space of the base body is therefore large enough, at least in the radial and/or axial direction, to accommodate the distributor element at least partially, preferably completely.

In particular, the base body has cavities that are not part of the channel system, whereby the cutting tool comprises a low weight.

Preferably, the distributor element comprises a material that is lighter than a material of the base body, in particular aluminum, plastic and/or steel. It is particularly preferred that the distributor element consists of such a material. Further preferably, the base body comprises steel or consists of steel. Particularly preferably, the distributor element comprises an overall lower specific weight than the base body.

Preferably, the interior space of the base body is delimited in the direction of the front end by a front cover, the front cover being attached, in particular welded and/or screwed, to the base body. In the direction of the rear end, the interior space is preferably delimited by a rear cover, which is preferably also attached, in particular welded, to the base body, in particular in a rotationally fixed manner.

In particular, the tool holder, especially the hollow shank taper, is preferably firmly connected to the rear cover, especially in a rotationally fixed manner.

The distributor element is configured and set up to conduct a cooling lubricant supplied to it to the at least one functional element.

In particular, the distributor element is configured and set up to distribute the cooling lubricant to a plurality of channels and thus to a plurality of functional elements. The distributor element comprises a channel structure with a plurality of interconnected channels that branch out when viewed in the direction of flow of the cooling lubricant in the operating state.

A channel is defined in particular as an elongated structure which is configured to be rotationally symmetrical, in particular with respect to the flow direction of a medium flowing therein, in particular the cooling lubricant, and which preferably comprises essentially a constant diameter and/or a constant cross-sectional shape. Preferably, the channel is configured tubular, in particular round in cross-section. Preferably, the channels of the channel system are configured and arranged to effect minimum quantity lubrication of the functional element—at least in the operating state of the cutting tool. Particularly preferably, the channel comprises a diameter which is 6 mm or less, preferably 4 mm or less, preferably 2.5 mm or less. Such a channel has a targeted, essentially one-dimensional direction of flow, whereby turbulence and dead spaces are avoided, thereby effecting efficient cooling and/or lubrication of the functional element, whereby the consumption of cooling lubricant is low and the cooling capacity is high.

According to a further development of the invention, it is provided that the distributor element—in the direction of the central axis—predominantly, in particular completely, extends through the base body. As a result, functional elements can be easily supplied with cooling lubricant during operation via the distributor element with little design effort.

Preferably, the distributor element is arranged radially within the base body, in particular in the interior space. At least the section inserted into the base body, in particular the entire distributor element, thus comprises a smaller diameter than the interior space of the base body.

Preferably, the distributor element is attached to the front cover and/or the rear cover on its respective end face, particularly in the area of the central axis. This achieves a high level of stability. Furthermore, an imbalance is avoided, in particular due to the central arrangement in the area of the central axis.

Particularly preferably, the front cover and/or the rear cover comprise recesses, especially in the central area of the central axis, in which the distributor element engages. It is particularly preferred that the recesses are configured as openings, with the distributor element engaging through at least one of the openings. This fixes the distributor element in the interior space, creating a high level of stability for the cutting tool.

Preferably, the distributor element comprises, in a rear section, which in particular extends through the opening of the rear cover, a feed channel through which the cooling lubricant is fed in particular to the distributor channel. The feed channel is particularly preferably arranged on the central axis. It is also preferred that there are no other feeding channels to the distributor channel, so that the feed channel is the only feeding channel. This creates an efficient cooling and/or lubrication system that is easy to implement in terms of design. In particular, the cooling lubricant can thus be supplied particularly easily and with little pressure, as the rotational forces in the area of the central axis are low during operation of the cutting tool.

Further preferably, the feed channel extends further up to the cooling lubricant inlet, which is preferably designed in the tool holder, in particular the hollow shank taper. As a result, the cooling lubricant can be supplied to the cutting tool in the area of the tool holder, whereby the design effort is low, as, in the operating state, the cutting tool is connected in the area of the tool holder to an external device anyway, in particular the machine tool, which preferably also provides the cooling lubricant.

According to a further development of the invention, it is provided that the distributor element extends at least in sections along the central axis—in the radial direction—completely between the central axis and an inner wall of the base body. This results in a supporting effect, whereby the distributor element is held particularly securely in the interior space of the base body, particularly in the radial direction. In particular, this also makes it possible to manufacture the distributor element from particularly lightweight and/or cost-effective materials whose strength is too low for them to be used absent this supporting effect without suffering damage during operation. This also avoids the need for additional channel elements between the distributor element and the base body.

The distributor element abuts the inner wall of the base body radially on the outside and is thus supported. Preferably, the distributor element completely fills the base body in such a way that the distributor element extends at least in sections, but preferably along the entire axial extent of the distributor element, over an entire inner radius and/or inner diameter, in particular the inner cross-section of the base body.

The distributor element is preferably configured from a compressible and/or lightweight material, whereby a lightweight material is understood to mean a material that is lighter than steel. The distributor element is compressible in such a way that it can be inserted into the interior space via an opening that is narrower than the inner diameter of the interior space, which is configured in particular as one of the openings of the covers, especially as the front opening of the front cover. The distributor element thus comprises—in particular in a compressed state—a smaller outer diameter than the front opening of the front cover and/or the rear opening of the rear cover. This means that the distributor element can also be inserted into the interior space after the base body and the two covers have been fitted, which simplifies assembly.

For the sake of completeness, it is mentioned here that the distributor element in the non-compressed, relaxed state preferably comprises a larger outer diameter than the front and/or rear opening. This ensures that the distributor element can no longer easily slip out of the interior space after insertion into the interior space and expansion, but is held securely in the interior space during operation of the cutting tool.

Preferably, the distributor element comprises plastic. It is particularly preferred that the distributor element consists of plastic. This makes the cutting tool inexpensive and comprises a sufficiently high stability and/or a low weight.

Alternatively, the distributor element comprises a smaller diameter or the same diameter as the opening of the front and/or rear cover, so that it can be inserted into the interior space without compression, in particular is pushed in.

According to a further alternative, the diameter of the distributor element corresponds to the interior diameter, wherein the distributor element—before the covers are fitted—can be pushed into the interior space, in particular is pushed in, and/or wherein the front opening of the front cover and/or the rear opening of the rear cover comprises a diameter which corresponds to the interior diameter, so that—even when the covers are fitted—the distributor element can be pushed into the interior space in particular without compression, in particular is pushed in.

According to a further development of the invention, it is provided that the distributor element comprises a central center axis channel, the course of which coincides with the central axis at least in sections. This creates a simple cooling lubricant supply that requires low pressure. In addition, if a plurality of functional elements are arranged distributed around the central axis in the circumferential direction, the distance to each functional element is the same, so that the design effort is low.

A central axis is understood here to mean in particular a central axis passing centrally through the base body and its imaginary, straight-line extension.

Preferably, the central axis channel lies completely on a section of the central axis. The at least one distributor channel extending transversely to the central axis preferably branches off from the center axis channel, with the distributor element particularly preferably comprising the distributor channel. This enables efficient cooling and/or lubrication, in particular with low cooling lubricant consumption, using simple design means.

Alternatively or additionally, the channel system comprises at least one channel running parallel to the central axis. This parallel channel is preferably configured within the distributor element.

According to a further development of the invention, it is provided that the distributor element—in the axial direction—is arranged between the base body and the rear end, in particular the tool holder, of the cutting tool. As a result, the further course of the channel from the distributor element to the at least one functional element, in particular the plurality of functional elements, can be arranged flexibly and efficiently, so that the design effort is always low.

The distributor element is arranged predominantly, in particular completely, in the recess of the rear cover and is fastened therein. Preferably, the distributor element is arranged behind the at least one functional element, in particular behind the rearmost functional element of the at least one functional element, whereby the flow path to the functional element, in particular to each functional element, is as short as possible, and detours are avoided.

According to a further development of the invention, it is provided that the distributor element comprises the at least one transversely aligned distributor channel. This makes efficient cooling and/or lubrication possible overall during operation. In addition, the design effort and the associated costs are low.

Preferably, the base body and/or the functional element accommodation also comprises at least one further channel running transverse to the central axis. This further improves cooling and/or lubrication during operation and further reduces the design effort and construction costs.

Furthermore, the channel system preferably comprises several distributor channels, in particular for each of the at least one functional element a distributor channel assigned thereto, respectively. This enables particularly efficient cooling and/or lubrication of the plurality of functional elements during operation of the cutting tool, whereby the design effort and costs are low.

According to a further development of the invention, it is provided that the distributor element is connected to a fluidically terminal channel section in a region of the functional element via at least one intermediate channel element. This creates a structurally simple connection between the distributor element and the terminal channel section, in particular the functional element.

Preferably, the distributor element is designed and configured by means of a plurality of channels extending transversely to the central axis in order to initially distribute the cooling lubricant to a plurality of intermediate channel elements, in particular intermediate channels configured therein, and to supply a plurality of functional elements with cooling lubricant via these.

Preferably, the distributor element—in the assembled state of the cutting tool—is arranged at a distance from the inner wall of the base body and/or comprises a smaller outer diameter than at least one of the end-face openings. This simplifies assembly, saves material and reduces the weight of the cutting tool.

The intermediate channel element is preferably designed and configured to bridge a radial distance. For this purpose, the intermediate channel element is aligned at least in sections, preferably completely transverse, in particular perpendicular to the central axis. Particularly preferably, the intermediate channel element, in particular the intermediate channel configured therein, is rectilinear and/or aligned transversely to the central axis. The transverse alignment creates a short and efficient flow path for the cooling lubricant, whereby rotational forces are utilized during operation of the cutting tool in order to push the cooling lubricant in the direction of the functional element, i.e. outwards in a radial direction.

The intermediate channel element is preferably connected radially on the inside to the distributor element and radially on the outside to the terminal channel section. The channel system preferably comprises a first sealing element, which seals the connection between the distributor element and the intermediate channel element. Furthermore, the channel system preferably comprises a second sealing element, which seals the connection between the intermediate channel element and the terminal channel section. Preferably, the intermediate channel element penetrates at least partially into the terminal channel section, with the section of the intermediate channel element penetrating into the terminal channel section being particularly preferably sealed off from the base body by means of a further sealing element, in particular an O-ring. As a result, the intermediate channel element is held securely and the seal is additionally improved.

The terminal channel section is preferably designed in the base body and/or the functional element accommodation and preferably comprises at least one first, in particular rectilinear, positioning channel, which is configured in particular as a bore, and preferably at least partially in the base body, by penetrating the wall of the base body. The first positioning channel ends—viewed in the direction of flow of the cooling lubricant—with an opening in the area of the at least one functional element, so that effective cooling and/or lubrication of the functional element is possible.

Particularly preferably, the terminal channel section additionally comprises a second, preferably rectilinear positioning channel, wherein the first positioning channel is assigned to a first functional element, in particular a cutting element, and wherein the second positioning channel is assigned to a second functional element, in particular a guide element. Starting from an opening of the terminal channel section facing the distributor element and/or the intermediate channel, the terminal channel section branches into the first positioning channel and preferably the second positioning channel. Preferably, the first and/or the second positioning channel are aligned transversely to the central axis. This creates a channel structure that is easy to construct and can be shaped, in particular by means of holes in the base body and/or the functional element accommodation. In addition, this channel structure is efficient in terms of cooling and/or lubrication, in particular by utilizing rotational forces during operation.

According to an alternative, preferred embodiment of the invention, it is further provided that the fluidically terminal channel section is provided in the region of the functional element without the intermediate channel element being provided. In this case, the terminal channel section is preferably connected directly to the distributor channel formed in the distributor element. As a result, the design complexity of the duct system is particularly low, as no additional intermediate channel element is required.

According to a further development of the invention, it is provided that the intermediate channel element is configured as a rigid and/or straight tube. This creates an intermediate channel element that is easy to assemble. In addition, the material requirement and weight of the cutting tool are low.

According to a further development of the invention, it is provided that the terminal channel section comprises a rectilinear section which is aligned in the same direction as the intermediate channel element, in particular the rigid tube, and/or oriented towards the connection point between the intermediate channel element, in particular the rigid tube, and the distributor element. This improves the supply of cooling lubricant to the terminal channel section and to the at least one functional element.

Preferably, the rectilinear section penetrates the base body, in particular its wall, and/or the functional element accommodation from radially outside to radially inside completely in a direction transverse, in particular perpendicular to the central axis. The rectilinear section is particularly preferably configured by a hole in the base body and/or the functional element accommodation. To mount the tube, it can be displaced through the terminal channel section, in particular the rectilinear section. This allows the tube to be safely inserted from outside the base body into the interior space of the base body, where it can be placed and sealed. Particularly preferably, a radially outer section of the intermediate channel element, in particular a radially outer tube section, remains in the terminal channel section, so that this radially outer section can be sealed particularly reliably with respect to the base body and/or the functional element accommodation and is held securely.

According to a further development of the invention, it is provided that the intermediate channel element is configured as a flexible channel element, in particular as a hose. As a result, a flexible and in particular short channel guide can be formed, whereby the cooling and/or lubrication comprises a low cooling lubricant consumption during operation of the cutting tool and a high cooling capacity is achieved. In addition, the weight of the cutting tool is very low as a result.

Preferably, the flexible channel elements are mounted via the front opening in the front cover, in particular after the distributor element has been inserted into the interior space and the front cover and the rear cover have been attached to the base body.

According to a preferred further development, it is provided here that the distributor element is arranged in a rear section of the cutting tool, in particular—in the axial direction—behind the base body and/or behind the functional element. This allows particularly short flow paths for the cooling lubricant to be designed with the flexible channel elements. The material requirement and weight are also particularly low as a result.

According to a further development of the invention, it is provided that the channel system comprises an outer channel structure which—viewed in the radial direction—runs outside the base body. As a result, the channel system can still be formed even if the interior space is not or not sufficiently accessible for the mounting of channel elements. Furthermore, the design effort is very low; in particular, the channel system can be subsequently configured with little effort, even on already finished cutting elements.

The outer channel structure thus runs in an area that comprises a greater distance from the central axis than the base body, in particular the tubular part of the base body. Preferably, an outer channel structure element is attached, in particular welded, to the outside of a circumferential surface of the base body.

Preferably, the outer channel structure is designed in a web element, in particular a rib-shaped web element, which is configured separately from the base body and is preferably welded onto the base body from the outside and/or extends over a large part of the axial extent of the base body, but at least as far as up to the at least one functional element, in particular the foremost functional element of the at least one functional element. The outer channel structure is fluidically connected at least indirectly, preferably directly, to the transversely aligned distributor channel. In order to connect these channel sections, i.e. the outer channel structure and the transversely aligned distributor channel, an opening is preferably formed in the base body, in particular in the wall of the tubular base body.

Preferably, the outer channel structure is connected to the terminal channel section. Particularly preferably, however, the outer channel structure comprises the terminal channel section, with the terminal channel section being formed in particular in the web element itself. In this case, in the operating state of the cutting tool, it is intended that the cooling lubricant opening emerges in the web element and thereby causes cooling and/or lubrication of the at least one functional element.

Preferably, the outer channel structure, in particular the web element, comprises channel sections that run essentially in the axial direction. In addition, the outer channel structure preferably comprises further channel sections which—in particular in the terminal area of the entire channel course—run transverse to the central axis. This means that—in the operating state of the cutting tool—the cooling lubricant can be brought to a distance from the circumferential surface of the base body, in particular at the same distance from the central axis as the functional elements, where it can be discharged from the channel system in a targeted manner in the area of the functional elements.

According to a further development of the invention, it is provided that a part of the channel system is formed in a wall of the base body. As a result, additional channel elements are avoided and the overall weight and material requirements are low.

Preferably, the part formed in the wall comprises at least one channel that extends essentially in the axial direction. Furthermore, the part formed in the wall is preferably aligned at an angle, in particular a constant angle, to the central axis. The angle to the central axis is preferably at most 5°, preferably at most 2°, preferably at most of 1°, preferably at most 0.5°. On the one hand, this improves the flow through the part formed in the wall and rotational forces are utilized during operation of the cutting tool. On the other hand, the smaller angular dimensions reduce the amount of material required, especially for long tools, as the wall thickness is kept low.

Alternatively, the part formed in the wall is arranged at a constant distance from the central axis. Particularly preferably, the part of the channel system formed in the wall comprises channel sections running parallel to the central axis, which are preferably formed by an elongated bore in the wall. As a result, the wall thickness is kept particularly low and the material requirement and weight are low.

According to a preferred further development of the invention, it is provided here that a wall thickness of the base body here is between 6 mm and 12 mm, preferably between 7 mm and 11 mm, preferably between 8 mm and 10 mm. This provides a high degree of stability.

Alternatively, in particular if no channels running parallel to the central axis are formed in the wall of the base body, it is provided that the wall thickness of the base body is between 4 mm and 7 mm, in particular between 5 mm and 6 mm. This results in a low weight and high stability.

Preferably, the distributor channels in the distributor element, the intermediate channels between the distributor element and the terminal channel area, and/or the channels in the terminal channel area, in particular the first and/or second positioning channel, comprise a constant internal diameter—at least when viewed individually, but preferably taken together. This enables an undisturbed flow of the cooling lubricant in the channel system during operation of the cutting tool, so that the cooling performance is high with low cooling lubricant consumption.

The problem is also solved in particular by providing a method for manufacturing a cutting tool, in particular in accordance with one of the aforementioned embodiments, wherein the base body is formed separately from the distributor element, wherein the distributor element is attached at least indirectly to the base body, and wherein a channel system for cooling lubrication of the at least one functional element is formed in the cutting tool, wherein at least one distributor channel extending transversely to a central axis of the base body is formed as part of the channel system. This results in the advantages already mentioned above in connection with the embodiments of the cutting tool. In particular, such a cutting tool is simple and inexpensive to construct. In addition, the cutting tool provides a high cooling capacity with low consumption of cooling lubricant during operation of the cutting tool.

Preferably, the base body is made of a different material than the distributor element. Particularly preferably, the base body comprises or consists of steel. The distributor element preferably comprises or consists of aluminum and/or an aluminum alloy. This ensures a high stability of the cutting tool on the one hand and a low weight of the cutting tool on the other.

Preferably, the distributor element is inserted into an interior space of the base body. The distributor element is preferably arranged rotationally symmetrically to the central axis, and in particular is attached directly or indirectly to the base body. Preferably, a front cover and a rear cover are attached to the end faces of the base body, with the front cover and the rear cover particularly preferably comprising at least one recess, particularly a central recess, in which the distributor element is arranged. The distributor element is particularly preferably fastened in a rotationally fixed manner by means of further pin and/or screw connections, so that a torque is transmitted from the covers, in particular from the rear cover, to the distributor element.

The base body is preferably attached to a tool holder in a rotationally fixed manner, in particular a hollow shank taper, or the base body comprises the tool holder. It is also possible for the base body to be indirectly connected to the tool holder via the rear cover, with the base body being attached to the rear cover and the rear cover being attached to the tool holder.

Preferably, the distributor channel is formed, in particular drilled, in the distributor element and/or the base body.

According to a further development of the invention, it is provided that the distributor element—after completion of the base body—is inserted into an interior space of the base body. This allows the individual components to be manufactured in different manufacturing steps, which simplifies manufacturing.

Preferably, the distributor element is inserted into the interior space after the front cover and/or the rear cover have been attached to the base body.

Furthermore, preferably, the distributor element is inserted into the base body through an opening at the front, in particular a narrowing, especially through an opening in the front cover. Alternatively, the distributor element is attached to the front and/or rear cover. Particularly preferably, the distributor element is inserted into a correspondingly shaped receiving opening of the rear cover—before or after the rear cover is mounted on the base body—and fixed therein, in particular in a rotationally fixed manner. This makes installation easy.

According to a further development of the invention, it is provided that a terminal channel section of the channel system is at least partially formed in the base body and/or a functional element accommodation. As a result, no further elements are required to form the terminal channel section, so that the weight and the manufacturing costs of the cutting tool are low.

According to a further development of the invention, it is provided that at least one intermediate channel element is inserted through the terminal channel section into the interior space of the base body and is connected to the distributor element in the interior space. This makes assembly of the cutting tool very simple and the weight is low. In particular, cavities in the base body can be bridged without the cooling lubricant running into these cavities during operation of the cutting tool. This also keeps the consumption of cooling lubricant low during operation and ensures efficient cooling of the functional element.

When the intermediate channel element is installed, it creates a fluidic connection between the distributor element and the terminal channel section.

To seal the connection point between the intermediate channel element and the distributor element, a first sealing element is arranged at the connection point. Accordingly, a second sealing element is arranged between the intermediate channel element and the terminal channel section, in particular the base body. This further improves the seal and prevents cooling lubricant leaks.

Preferably, the intermediate channel element is inserted in such a way that a radially outer end of the intermediate channel element—in the inserted, in particular assembled state—still remains partially in the terminal channel section and is thereby fluidically connected to it and preferably at the same time—at least in the direction perpendicular to the direction of insertion—is fixed by the wall of the terminal channel section. A corresponding flow opening in the intermediate channel element is preferably aligned with a channel of the terminal channel section assigned to the flow opening, in particular a first or second positioning channel. Alternatively, the positioning channel is formed by a bore, whereby the bore bores at least partially through both the base body and/or the functional element accommodation and the intermediate channel element itself in such a way that an intermediate channel formed in the intermediate channel element is opened up by drilling and a fluidic connection for the cooling lubricant is thereby created. Preferably, a first such bore—and thus a first positioning channel—is formed to provide cooling and/or lubrication of a cutting element, and a second such bore—and thus a second positioning channel—is formed to provide cooling and/or lubrication of a guide element. This creates an efficient cooling and lubrication structure that is easy to manufacture.

According to a further development of the invention, it is provided that a channel guide element is introduced into the terminal channel section—in particular after the intermediate channel element has been introduced into the interior space of the base body-which at least partially defines the channel structure in the terminal channel section, in particular narrows a flow cross-section. This improves the guidance of the cooling lubricant during operation of the cutting tool and thus the cooling and/or lubrication and reduces the need for cooling lubricant.

In particular, the channel guide element reduces the flow cross-section for the cooling lubricant in the area of the terminal channel section, especially the rectilinear section, which is used in particular for mounting the intermediate channel element. This improves the flow properties, improves cooling and/or lubrication and reduces the consumption of cooling lubricant during operation.

Preferably, the channel structure of the channel guide element comprises a channel guide section aligned in the direction of the intermediate channel element and/or the at least one transversely aligned distributor channel, which is preferably arranged on the radially inner side of the channel guide element and is connected to the intermediate channel element and/or the distributor channel. The channel structure of the channel guide element preferably comprises at least one bend, a first opening to the first positioning channel and/or a second opening to the second positioning channel. It is important that the channel guide section shall be connected to the first and/or second positioning channel and is connected in the fully assembled state. As a result, an efficient cooling lubricant structure is created and cooling and/or lubrication are improved.

Preferably, the channel guide element comprises a fixing element which fixes the intermediate channel element from the outside. Thus, the intermediate channel element is held in position in an easy manner.

Preferably, the fixing element comprises a screw element, which is screwed into a thread of the base body or the functional element accommodation. The intermediate channel element is firmly clamped in particular in its position between the distributor element and the terminal channel section.

According to a further development of the invention, it is provided that the distributor element is compressed for insertion into the base body-preferably exclusively in the elastic range of the material used. As a result, the distributor element is held in the base body without further aids after insertion into the base body.

Preferably, an outer diameter of the distributor element in the non-compressed state corresponds to an outer diameter of the interior space of the base body. This gives the distributor element additional support so that it is supported against displacement, particularly in the radial direction.

Particularly preferably, the distributor element comprises at least one distributor channel which extends from a center axis channel, in particular an axial center axis channel, to a wall of the base body, in particular the terminal channel section configured therein. This at the same time creates a closed channel system which does not require any additional channel elements, in particular intermediate channel elements.

According to a further development of the invention, it is provided that a part of the channel system, in particular a part running parallel to the central axis, is formed in a wall of the base body. As a result, the cooling lubricant can be distributed in the axial direction via this part of the channel system, so that the design is simple, weight is saved and, in particular, no additional axial channel structures are required.

The part of the channel system formed in the wall preferably comprises an elongated bore running parallel to the central axis of the base body, with the elongated bore preferably penetrating the base body predominantly, in particular completely, in the axial direction. The elongated bore is at least introduced as far as up to the functional element furthest away in the axial direction, so that all functional elements can be supplied with cooling lubricant via the elongated bore.

The overall advantage of the present cutting tool is that it can be manufactured without additive manufacturing processes and thus in an inexpensive way. The cutting tool and its channel system are suitable, in particular configured and designed, to provide minimum quantity lubrication, which comprises a particularly high cooling capacity with a low cooling lubricant requirement.

The descriptions of the cutting tool and the method are to be understood as complementary to each other. In particular, features of the cutting tool explicitly or implicitly described in connection with the method are preferably features of the cutting tool individually or in combination with each other. Method steps that have been explicitly or implicitly described in connection with the cutting tool are preferably steps of a preferred embodiment of the method, either individually or in combination with one another. In particular, the method preferably includes at least one step resulting from at least one feature of the cutting tool.

The invention is explained in more detail below with reference to the drawings. They show:

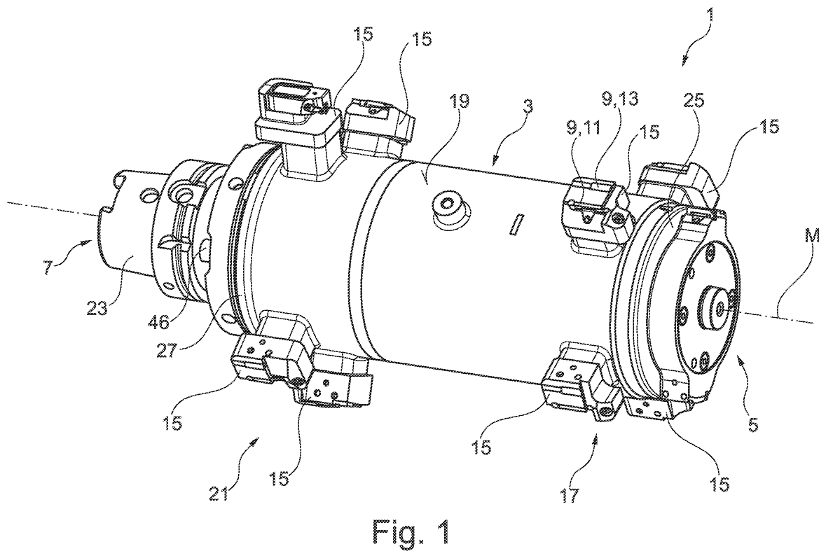

FIG. 1 a perspective view of a cutting tool according to a first embodiment,

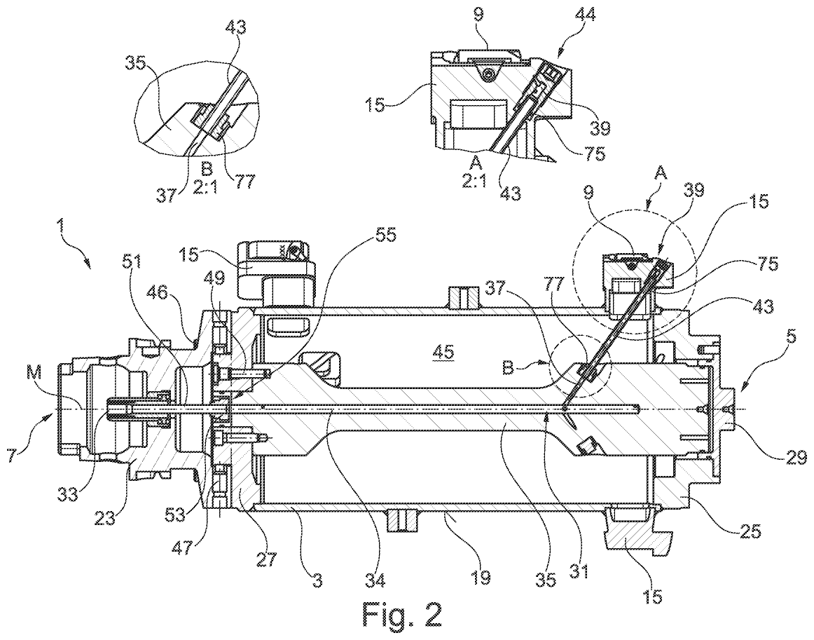

FIG. 2 a sectional view of the cutting tool according to the first embodiment,

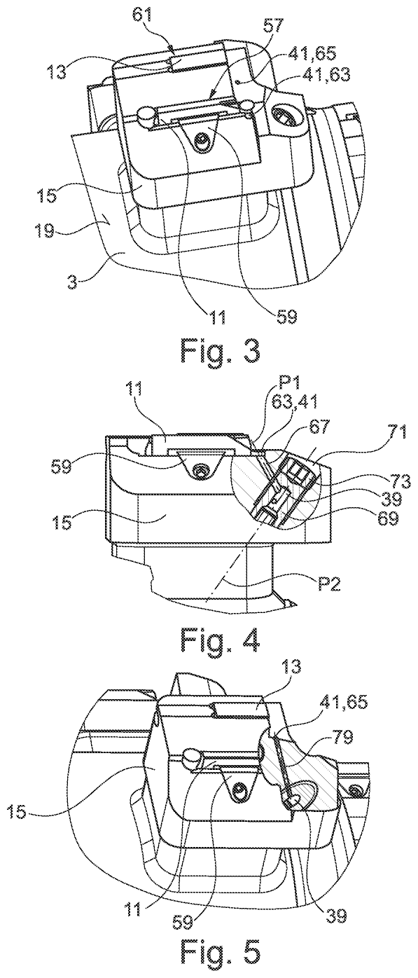

FIG. 3 an enlarged view of a functional element accommodation in a perspective view,

FIG. 4 a sectional view of the functional element accommodation shown in FIG. 3 from the side,

FIG. 5 a further sectional view of the functional element accommodation shown in FIGS. 3 and 4 in an alternative perspective view,

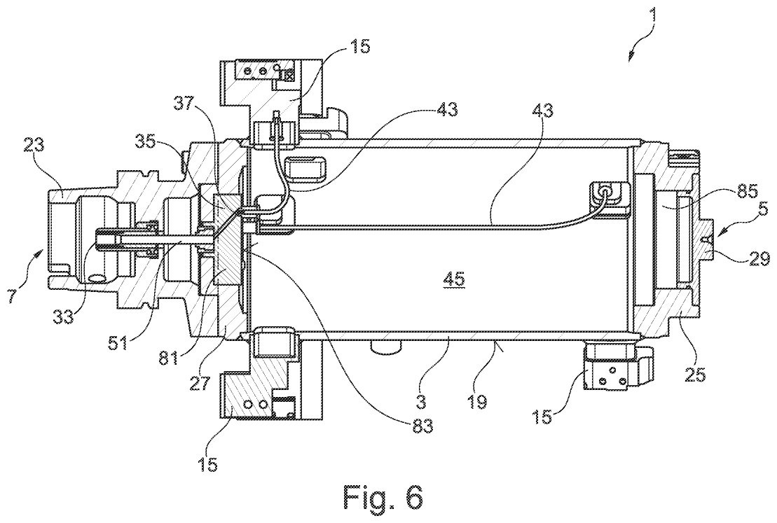

FIG. 6 a sectional view of a cutting tool according to a second embodiment,

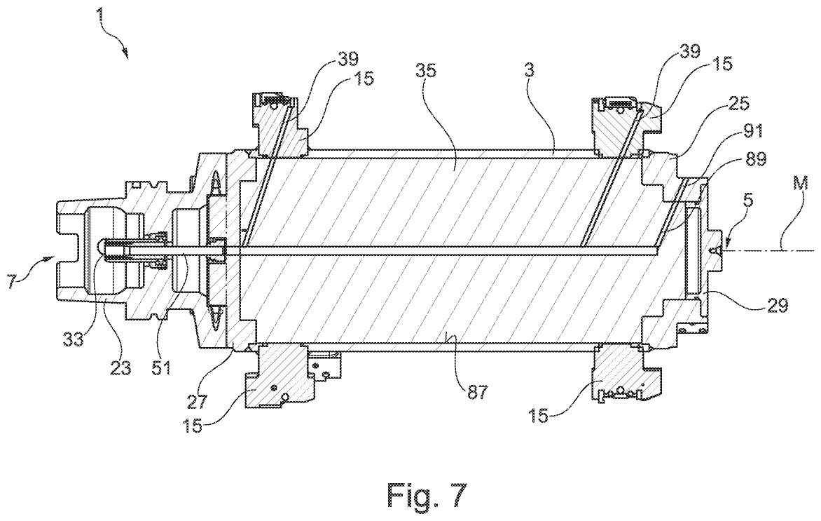

FIG. 7 a sectional view of a cutting tool according to a third embodiment,

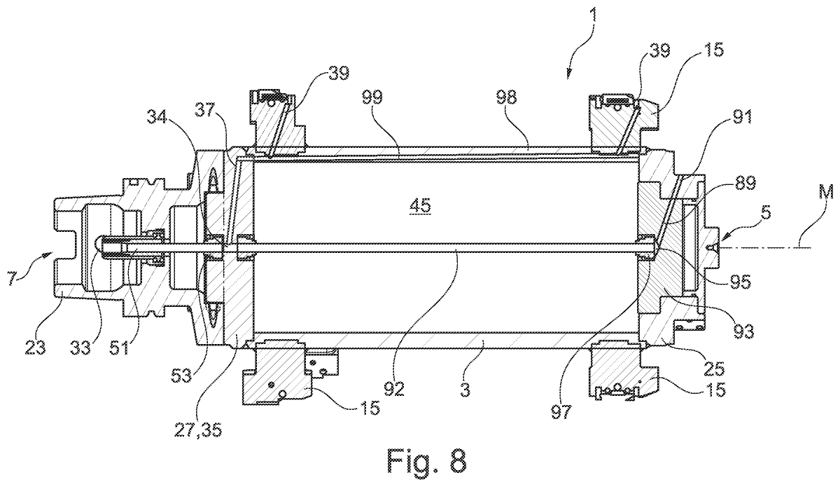

FIG. 8 a sectional view of a cutting tool according to a fourth embodiment,

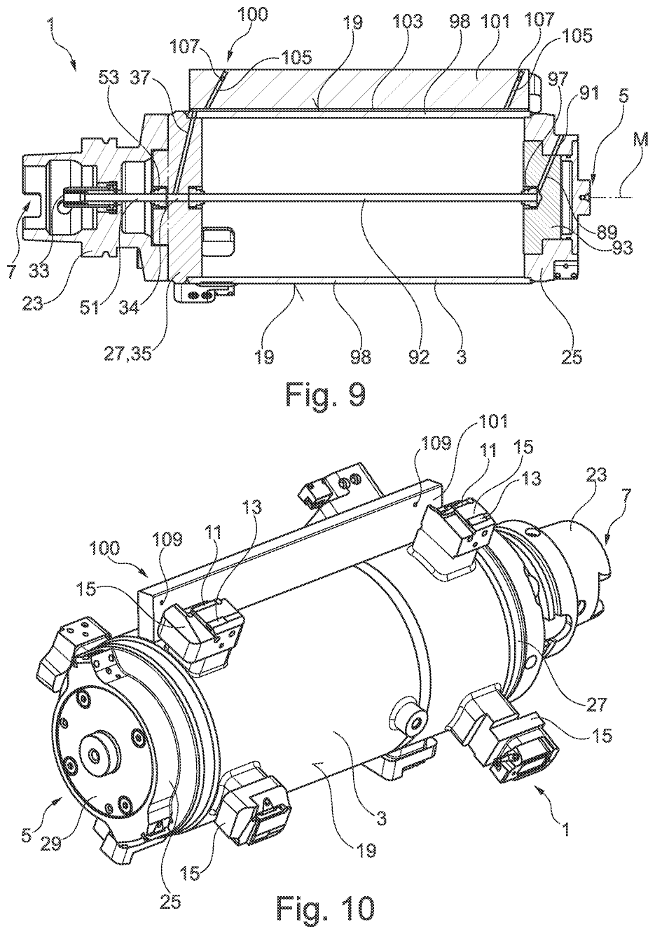

FIG. 9 a sectional view of a cutting tool according to a fifth embodiment, and

FIG. 10 a perspective view of the cutting tool according to the fifth embodiment.

FIG. 1 shows a cutting tool 1 according to a first embodiment with a central axis M, a base body 3, a front end 5 and a rear end 7. The cutting tool 3 is intended and configured to rotate about the central axis M, in particular to machine a workpiece not shown here, in particular to cut, drill and/or mill. The cutting tool 1 comprises at least one functional element 9 for guiding in the workpiece and/or for machining the workpiece, here in particular a plurality of functional elements 9, which are at least partially grouped in functional element pairs, wherein a functional element pair comprises a cutting element 11 and a guide element 13, respectively.

The functional elements 9 are each fastened here in a functional element accommodation 15.

For the sake of clarity, in FIG. 1 only one of the functional element pairs is provided with the reference signs for the functional elements 9, i.e. the cutting elements 11 and the guide elements 13. Preferably, however, each of the functional element accommodations 15 shown here comprises at least one functional element 9, in particular a cutting element 11 and/or a guide element 13. This increases the processing quality of the workpiece and/or the smooth running during operation of the cutting tool 1.

Overall, therefore, at least two groups of functional elements 9 axially offset from one another are recognizable, a first group 17 being arranged in the front region of the cutting tool 1 distributed in the circumferential direction around the central axis M on an outer circumferential surface 19 of the cutting tool. A second group 21 of functional elements 9 and corresponding functional element accommodations 15 is arranged in a rear area on the circumferential surface 19 of the base body 3, which is configured in particular in the form of a tube. This makes it possible to machine the workpiece in two stages, with rough machining being carried out in a first stage and fine machining being carried out in a second stage, for example.

A tool holder 23, which is preferably configured as a hollow shank cone, is arranged here at the rear end 7 of the cutting tool 1. The cutting tool 1 can be clamped in a machine tool not shown here via this tool holder 23, whereby the machine tool is configured to introduce a torque into the cutting tool 1 via the tool holder 23.

The base body 3, which is configured here in a tubular shape, is attached at its front end to a front cover 25. In the direction of the rear end 7, a rear cover 27 is arranged between the tool holder 7 and the base body 3 and is connected to these in a rotationally fixed manner. This creates a stable cutting tool which, in particular, can efficiently transmit the introduced torque to the functional elements.

An opening is configured here in the front cover 25, which in FIG. 1 is closed by a further cover element 29. The further cover element 29 is attached to the front cover 25, in particular by means of screw connections, whereby the further cover element 29 can be attached and removed quickly and easily, in particular to make an interior of the base body accessible for construction and/or maintenance purposes.

FIG. 2 shows the embodiment of the cutting tool 1 shown in FIG. 1 in an axial sectional view along the central axis M. It can be seen in FIG. 2 that the cutting tool 1 comprises a channel system 31 for supplying the at least one functional element 9 with a cooling lubricant. The channel system 31 shown here extends in particular from a cooling lubricant inlet 33 in the area of the tool holder 23 via a center axis channel 34 in a distributor element 35, a distributor channel 37 aligned transversely to the central axis, a terminal channel section 39 up to at least one cooling lubricant outlet 41, here in particular two cooling lubricant outlets 41.

Due to the representation selected in FIG. 2, the cooling lubricant outlets 41 are not visible there. In this respect, reference is therefore made at this point to FIGS. 3-5, in which the cooling lubricant outlets 41 are shown enlarged.

Starting from the center axis channel 34, the transversely extending distributor channel 37 extends first through the distributor element 35 and then through an intermediate channel element 43 into the terminal channel section 39. The intermediate channel element 43 is configured here in particular as a rigid tube, which can be introduced into an interior space 45 of the base body 3 from radially outside to inside via the terminal channel section 39, in particular a part 44 of the terminal channel section 39 that extends transversely as it were, in particular a bore. During the manufacturing of the cutting tool, the intermediate channel element 43 is thus preferably introduced into the interior of the base body 3 via this transversely extending part 44 of the terminal channel section 39, which simplifies the design.

Further, in FIG. 2 fastening means 46 and adjusting means 47 can be seen, in particular alignment screws, in the rear area, by means of which the tool holder is fastened to the rear cover 27, in particular connected in a rotationally fixed manner, and axially aligned with one another.

In addition, further fastening means 49 can be seen, which connect the distributor element 35 to the rear cover 27 in a rotationally fixed manner. As a result, the distributor element 35 and in particular the center axis channel 34 configured therein is aligned with a feed channel 51, which extends from the cooling lubricant inlet 33 up to the distributor element 35. The feed channel 51 is sealed against the distributor element 35 at the connection point 55 by a first sealing element 53.

As can be seen in particular in the sectional view in FIG. 2, the distributor element 35 is configured separately from the base body 3, which simplifies the design. In addition, this allows different materials to be selected for manufacturing the distributor element 35 on the one hand and the base body 3 on the other hand, whereby the respective materials can be adapted to the specific requirements of the distributor element 35 and the base body 3. Preferably, the base body 3 is at least partially, preferably completely, configured from a stable material, in particular steel. The distributor element 35 is at least partially, preferably completely, manufactured from a lightweight material, in particular aluminum or an aluminum alloy. A lightweight material is understood here in particular to be a material that is lighter than the material of the base body. As a result, the material properties are combined with one another in an advantageous manner, so that the cutting tool is both light and stable.

FIG. 3 shows the functional element accommodation 15 in an external perspective view. It is easy to see how the cutting element 11 is clamped in a cutting element accommodation 57 by means of a clamping element 59. The guide element 13 is correspondingly arranged in a guide element accommodation 61 and fastened therein. This means that the functional elements 9, i.e. the cutting element 11 on the one hand and the guide element 13 on the other, can be replaced quickly, easily and independently of each other in the event of damage.

The cooling lubricant outlets 41 can also be seen here, with a first cooling lubricant outlet 63 arranged in the area of the cutting element 11 and a second cooling lubricant outlet 65 arranged in the area of the guide element 13.

The entire functional element accommodation 15 is preferably either configured integrally with the base body 3 or—as in the embodiment shown here—attached to the circumferential surface 19 of the base body, in particular welded to it. As a result, the cutting tool 1 can be manufactured cost-effectively and with little effort.

FIG. 4 shows the functional element accommodation 15 in a lateral partial sectional view, whereby a first positioning channel 67 of the terminal channel section 39 lies along its positioning axis P1 in the image plane. As a result, the cooling lubricant can be applied precisely in the area of the cutting element 11 so that effective cooling and/or lubrication takes place there during operation of the cutting tool 1.

Furthermore, another axis P2 can be seen in FIG. 4, which extends through a radially inner part of the terminal channel section 39 and—in the embodiment shown here—coincides in particular with the orientation of the intermediate channel element 43 shown in FIG. 2 and the orientation of the distributor channel 37 aligned transversely to the central axis M. This ensures particularly efficient transport of the cooling lubricant along the channel system. In particular, rotational forces are thereby utilized during operation of the cutting tool 1 in order to push the cooling lubricant in a targeted manner in a radially outward direction and in the direction of the cooling lubricant outlets 41.

Preferably, the intermediate channel element 43 is inserted into the interior space 45 of the base body 3 along the further axis P2 during the manufacturing of the cutting tool 1.

The terminal channel section 39 comprises here in particular a channel guide element 69, in which the channels of the terminal channel section 39 are at least partially formed. This channel guide element 69 results in particular in a narrowing of the original bore 71, whereby on the one hand the flow cross-section for the cooling lubricant is kept small and on the other hand the intermediate channel element 43 is fixed in its position. In particular, the small flow cross-section results in lower cooling lubricant consumption during operation of the cutting tool 1. The channel guide element 69 is held securely in the bore 71 by means of a screw connection 73. The channel guide element 69 of the terminal channel section 39 is sealed with respect to the intermediate channel element 43 by means of a second sealing element 75, which is shown in particular in FIG. 2 and especially in detail A in FIG. 2. The second sealing element is preferably configured as an O-ring. This creates a reliable seal and prevents cooling lubricant leaks, which also keeps cooling lubricant consumption low during operation of the cutting tool 1.

In detail B in FIG. 2, a third sealing element 77 is shown, which creates a seal between the intermediate channel element 43 and the distributor element 35. This also prevents leaks in the channel system 31.

FIG. 5 shows the functional element accommodation 15 in an alternative partial sectional view, so that here in particular a second positioning channel 79 is located in the image plane. This second positioning channel 79 ends at the second cooling lubricant outlet 65 in the area of the guide element 13. As a result, the cooling lubricant can be applied precisely in this area during operation of the cutting tool 1 in order to achieve efficient cooling of the guide element 13.

FIG. 6 shows a cutting tool 1 according to a second embodiment, wherein the intermediate channel elements 43 are configured flexible, in particular as hoses. As a result, the intermediate channel elements 43 can be mounted easily and flexibly. In addition, the weight of the cutting tool 1 is very low as a result.

According to the second embodiment, the distributor element 35 does not extend through the interior space 45 of the base body 3. Rather, the distributor element 35 is arranged in a rear edge region of the interior space 45, in particular—in the axial direction—at least partially behind the base body. The distributor element 35 is preferably arranged in a central recess 81 on the rear cover 27. The central recess 81 is preferably configured to be rotationally symmetrical to the central axis, so that an imbalance during operation of the cutting tool 1 is avoided.

The distributor element 35 comprises here the distributor channel 37, which is aligned transversely to the central axis M. The distributor channel 37 ends—viewed in the direction of flow of the cooling lubricant—at an end face 83 of the distributor element 35, a surface normal of the end face 83 being aligned in the direction of the front end 5 and, in particular, parallel to the central axis M. The end face 83 is thus preferably aligned parallel to a cross-sectional area through the base body 3 and perpendicular to the image plane. Further preferably, the end face 83—viewed in the axial direction—is behind the rearmost of the functional elements, so that each of the functional elements 9 can be, in particular is, well connected to the distributor channels 37 in the distributor element 35, in particular the connection points arranged on the end face 83. As a result, the end of the distributor channel 37 is easily accessible from the front through an opening 85 in the front cover 25, so that the intermediate channel elements 43 can be easily connected to the distributor element 37 from the front. This significantly simplifies the manufacturing and maintenance of the cutting tool 1.

FIG. 7 shows a cutting tool 1 according to a third embodiment in a sectional view along the central axis M. According to the third embodiment, the distributor element 35 is configured in such a way that it extends along the central axis M at least in sections—in the radial direction—completely between the central axis and an inner wall 87 of the base body 3. As a result, the distributor element 35 is held securely in the interior space 45 of the base body 3.

As is also provided in the cutting tool 1 according to the first embodiment, the distributor element 35 here also extends—in the axial direction—completely through the base body 3, wherein it is fixed at the front and/or rear in particular in central recesses of the front cover 25 and/or rear cover 27 and is thereby held securely in the interior space 45.

Preferably, the interior space 45 is completely or at least almost completely filled by the distributor element 35.

In addition, the distributor channels 37 are formed in the distributor element 35 and merge directly into the terminal channel section 39 in the region of the inner wall 87. Preferably, no additional intermediate channel elements 43 are arranged between the distributor element 35 and the terminal channel section 39. This simplifies manufacturing, as these additional intermediate channel elements 43 do not have to be additionally manufactured and installed.

Preferably, an additional, transversely extending distributor channel 89 is configured here, which branches off from the center axis channel 34 in the front region of the center axis channel 34. In the radially outer region of the distributor element 35, the additional distributor channel 89 merges into a front channel section 91, which is formed in the front cover 25. This also enables cooling and/or lubrication in the front area of the cutting tool, in particular the front cover 25.

FIG. 8 shows a cutting tool 1 according to a fourth embodiment in a sectional view along the central axis M. The rear cover 27 is configured as a distributor element 35. In particular, the distributor channel 37 is formed in the rear cover 27.

In FIG. 8, a further center axis channel 92 extends continuously through the base body 3, wherein the further center axis channel 92 is configured separately from the distributor element 35 and adjoins the center axis channel 34 of the distributor element 35 in the axial direction. The center axis channel 34 is connected at the front end of the further center axis channel 92 to an alternative distributor element 93, so that a fluidic connection is configured to the additional distributor channel 89 formed in the alternative distributor element 93. The additional distributor channel 89 merges into the channel section 91 formed in the front cover 25. This enables cooling and/or lubrication of the front area of the cutting tool 1.

Furthermore, the connection point 95 between the center axis channel 34 and the alternative distributor element 93 is sealed by means of a fourth sealing element 97. This prevents cooling lubricant leaks.

In the rear area of the cutting tool 1, the distributor channel 37 merges into a longitudinal channel 99, which extends through the wall 98 of the base body 3, in particular at a constant angle, here particularly of 0.5°, to the central axis M. The longitudinal channel 99 preferably extends over a large part of the longitudinal extent of the base body 3, but at least up to an axial position of one of the functional element accommodations 15, preferably up to the foremost functional element accommodation 15. This enables cooling and/or lubrication of the functional elements 9, whereby the formation and assembly of a separately configured distributor element 35 is avoided.

The cutting tools 1 according to the second, third and fourth embodiments shown in FIGS. 6, 7 and 8 preferably comprise functional element accommodations 9, which comprise at least one of the features, in particular the cutting element 11, the guide element 13, the first positioning channel 67 and/or the second positioning channel 79, of the functional element accommodations shown in FIGS. 3 to 5.

According to an alternative embodiment not shown here, the rear cover 27 is not configured as a distributor element 35. Instead, according to the alternative embodiment not shown here, the distributor element 35 is configured separately from the rear cover 27, as in the first, second and/or third embodiment. In contrast to the first three embodiments, however, a fluidic connection is configured between the distributor element 35 and the channel structure in the wall 98 of the base body 3, in particular the longitudinal channel 99. This creates an easy-to-construct cooling structure with good cooling performance and efficiency, in particular low cooling lubricant consumption.

FIG. 9 shows a cutting tool 1 according to a fifth embodiment in a sectional view along the central axis M. As in the cutting tool 1 according to the fourth embodiment, which is shown in FIG. 8, in the cutting tool 1 according to the fifth embodiment the rear cover 27 is configured as a distributor element 35 and comprises the distributor channel 37. The further center axis channel 92 and the front area with the alternative distributor element 93, the front channel section 91 and the additional distributor channel 89 are configured analogously to the cutting tool 1 according to the fourth embodiment, so that reference is made in this respect to the preceding description.

The cutting tool 1 according to the fifth embodiment comprises an outer channel structure 100 with a web element 101, which is attached to the outside of a circumferential surface 19 of the base body 3, in particular welded to it. An elongated channel structure 103 is configured by the web element 101, which extends essentially parallel to the central axis. In the embodiment shown here, the elongated channel structure 103 is limited in particular on the one hand by the web element 101 and on the other hand by the circumferential surface 19 of the base body 3.

Alternatively, it is possible to form the elongated channel structure completely within the web element 101. This allows cooling lubricant to flow through the cutting tool in the axial direction.

The elongated channel structure 103 is on the one hand fluidically connected to the distributor channel 37, in particular in that the distributor channel 37, starting from the distributor element 35, penetrates the wall 98 of the base body 3 and thus opens into the elongated channel structure 103 at the circumferential surface 19 of the base body 3. The cooling lubricant can now be transported in an axial direction along the elongated channel structure 103. At least one distributor channel, in particular web channel 105, aligned transversely to the central axis M is formed in the web element 101, which is preferably arranged in a region of an axial position of the functional element accommodation 15 and adjacent to the functional element accommodation 15 in the circumferential direction, as can also be seen in FIG. 10.

The web channel 105 opens into a terminal channel section 107, which comprises a channel opening 109 and is oriented in the direction of the functional element 15. This makes it possible to distribute the cooling lubricant into the area of the functional element 15 during operation of the cutting tool 1 and thus effect efficient cooling and/or lubrication of the functional element 9. In particular, holes and channels in the functional holding element 15 itself can be avoided, which reduces the design effort. In addition, by means of the web element 101 and the elongated channel structure 103, it is possible to retrofit a cutting tool 1 without a cooling channel system, in particular according to the invention, with little effort in such a way that efficient cooling and/or lubrication, in particular minimum quantity lubrication of the functional elements 9, is provided.

Since the terminal channel section in FIG. 9 runs towards the viewer, only the cross-section of the terminal channel section is visible.

FIG. 10 shows the cutting tool 1 according to the fifth embodiment in an external view, which is shown essentially reversed with respect to the representation in FIG. 1, so that the side of the cutting tool 1 facing away in FIG. 1 is facing the viewer in FIG. 10. It is particularly easy to see how the channel openings in the area of the functional element accommodations 15 are oriented towards the same, in particular towards the cutting element 11, which creates efficient cooling and/or lubrication, in particular of the cutting element 11.

Furthermore, the three-dimensional arrangement of the web element 101 on the one hand and the functional element accommodations 15 on the other hand, in particular in relation to one another, is also illustrated here once again.

1. Cutting tool, in particular for cutting, drilling and/or milling a workpiece, with a base body having a central axis, a front end and a rear end, wherein the cutting tool comprises at least one functional element for guiding and/or machining the workpiece, wherein the cutting tool comprises a channel system for supplying the at least one functional element with a cooling lubricant, wherein the channel system comprises a distributor element configured separately from the base body, and wherein the channel system comprises at least one distributor channel aligned transversely to the central axis.

2. Cutting tool according to claim 1, characterized in that the distributor element—in the direction of the central axis—predominantly engages through the base body.

3. Cutting tool according to claim 1, characterized in that the distributor element extends along the central axis at least in sections—in the radial direction—completely between the central axis and an inner wall of the base body.

4. Cutting tool according to claim 1, characterized in that the distributor element comprises a central center axis channel, the course of which coincides at least in sections with the central axis.

5. Cutting tool according to claim 1, characterized in that the distributor element is arranged in the axial direction between the base body and the rear end of the cutting tool.

6. Cutting tool according to claim 1, characterized in that the distributor element comprises the at least one transversely aligned distributor channel.

7. Cutting tool according to claim 1, characterized in that the distributor element is connected via at least one intermediate channel element to a fluidically terminal channel section in a region of the functional element.

8. Cutting tool according to claim 1, characterized in that the intermediate channel element is configured as a rigid tube.

9. Cutting tool according to claim 1, characterized in that the terminal channel section comprises a rectilinear section which is oriented in the same direction as the intermediate channel element and/or towards a connection point between the intermediate channel element and the distributor element.

10. Cutting tool according to claim 1, characterized in that the intermediate channel element is configured as a flexible channel element.

11. Cutting tool according to claim 1, characterized in that the channel system comprises an outer channel structure which—in the radial direction—extends outside the base body.

12. Cutting tool according to claim 1, characterized in that a part of the channel system is formed in a wall of the base body.

13. Method for manufacturing a cutting tool, in particular according to one of the preceding claims, wherein the base body is configured separately from the distributor element, wherein the distributor element is attached at least indirectly to the base body, and wherein a channel system for cooling lubrication of the at least one functional element is designed in the cutting tool, wherein at least one distributor channel extending transversely to a central axis of the base body is configured as part of the channel system.

14. Method according to claim 13, characterized in that the distributor element—after completion of the base body—is introduced into an interior space of the base body.

15. Method according to claim 13, characterized in that a terminal channel section of the channel system is configured at least partially in the base body and/or a functional element accommodation.

16. Method according to claim 13, characterized in that at least one intermediate channel element is introduced through the terminal channel section into the interior space of the base body and is connected to the distributor element in the interior space.

17. Method according to claim 13, characterized in that a channel guide element is introduced into the terminal channel section, which at least partially defines the channel structure in the terminal channel section.

18. Method according to claim 13, characterized in that the distributor element is compressed for insertion into the base body—preferably exclusively in the elastic region of the material used.

19. Method according to claim 13, characterized in that a part of the channel system, in particular a part extending parallel to the central axis, is formed in a wall of the base body.
